(19) United States
(12) Patent Application Publication
(10) Pub. No.: US 2014/0095870 A1
(43) Pub. Date: Apr. 3, 2014

(54) DEVICE, METHOD, AND SYSTEM FOR CONTROLLING ACCESS TO WEB OBJECTS OF A WEBPAGE OR WEB-BROWSER APPLICATION

(71) Applicants: Prashant Dewan, Hillsboro, OR (US); David M. Durham, Beaverton, OR (US)

(72) Inventors: Prashant Dewan, Hillsboro, OR (US); David M. Durham, Beaverton, OR (US)

(21) Appl. No.: 13/631,419

(22) Filed: Sep. 28, 2012

(51) Int. Cl. G06F 21/00; H04L 9/32

(52) U.S. Cl. 713/167

(57) ABSTRACT

A method and device for securely displaying web content with secure web objects across untrusted channels includes downloading web content from a web server. The web content includes tags that a web browser uses to authenticate the current user and identify encrypted web objects packaged in the web content. The computing device authenticates the current user using a biometric recognition procedure. If the current user is authenticated and determined to be authorized to view the decrypted web object, the encrypted web object is decrypted and displayed to the user. If the user is unauthenticated, the encrypted web object is displayed in place of the encrypted web object such that the decrypted web object is displayed for only authorized persons physically present at the computing device. The biometric recognition procedure and web object decryption processes are protected through secure media path circuitry and secure memory.

### BACKGROUND

The sharing of information through the Internet has become pervasive throughout modern society. Information regarding nearly every aspect of life can be discovered through website content accessible to the general public; however, other information is intended to be kept strictly confidential. As such, the confidentiality of such information is an important consideration for many users. Web developers have implemented a wide array of web development techniques and languages directed at securing a particular user's confidential information. Typically, such confidentiality is ensured by providing the user with a token or login in which to access the secure data or web objects. In doing so, the user is either granted or denied access to a particular webpage or web browser application as a whole.

Biometric recognition is a procedure is which a person can be identified or verified by comparing the captured biometric data of an individual to some known biometric data. Although facial images and fingerprints appear to predominate, various other biometrics may be used to accurately identify a particular individual. However, some biometric recognition systems require some training to allow the biometric recognition system to accurately compare captured biometric data to the known biometric data and thereby identify an individual.

### BRIEF DESCRIPTION OF THE DRAWINGS

The concepts described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 is a simplified block diagram of at least one embodiment of a system for securely displaying web content;

FIG. 2 is a simplified block diagram of at least one embodiment of a environment of a web server of the system of FIG. 1;

FIG. 3 is a simplified block diagram of at least one embodiment of a environment of a client computing device of the system of FIG. 1;

FIG. 4 is a simplified flow diagram of at least one embodiment of a method for securely registering biometric authentication data and cryptographic keys;

FIG. 5 is a simplified flow diagram of at least one embodiment of a method for securely generating web content on the web server of FIG. 1;

FIGS. 6 and 7 is a simplified flow diagram of at least one embodiment of a method for securely displaying web content on the client computing device of FIG. 1; and

FIG. 8 is a simplified flow diagram of at least one embodiment of a method for authenticating a current user of the client computing device of FIG. 1.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present disclosure. It will be appreciated, however, by one skilled in the art that embodiments of the disclosure may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention implemented in a computer system may include one or more bus-based interconnects between components and/or one or more point-to-point interconnects between components. Embodiments of the invention may also be implemented as instructions carried by or stored on a transitory or non-transitory machine-readable (e.g., computer-readable) medium, which may be read and executed by one or more processors. A machine-readable medium may be embodied as any device, mechanism, or physical structure for storing or transmitting information in a form readable by a machine (e.g., a computing device). For example, a machine-readable medium may be embodied as read only memory (ROM); random access memory (RAM); magnetic disk storage media; optical storage media; flash memory devices; mini- or micro-SD cards, memory sticks, electrical signals, and others.

In the drawings, specific arrangements or orderings of schematic elements, such as those representing devices, modules, instruction blocks, and data elements, may be shown for ease of description. However, it should be understood by those skilled in the art that the specific ordering or arrangement of the schematic elements in the drawings is not meant to imply that a particular order or sequence of processing, or separation of processes, is required. Further, the inclusion of a schematic element in a drawing is not meant to imply that such element is required in all embodiments or that the features represented by such element may not be included in or combined with other elements in some embodiments.

In general, schematic elements used to represent instruction blocks may be implemented using any suitable form of machine-readable instruction, such as software or firmware applications, programs, functions, modules, routines, processes, procedures, plug-ins, applets, widgets, code fragments and/or others, and that each such instruction may be implemented using any suitable programming language, library, application programming interface (API), and/or other software development tools. For example, some embodiments may be implemented using Java, C++, and/or other programming languages. Similarly, schematic elements used to represent data or information may be implemented using any suitable electronic arrangement or structure, such as a register, data store, table, record, array, index, hash, map, tree, list, graph, file (of any file type), folder, directory, database, and/or others.

Further, in the drawings, where connecting elements, such as solid or dashed lines or arrows, are used to illustrate a connection, relationship or association between or among two or more other schematic elements, the absence of any such connecting elements is not meant to imply that no connection, relationship or association can exist. In other words, some connections, relationships or associations between elements may not be shown in the drawings so as not to obscure the disclosure. In addition, for ease of illustration, a single connecting element may be used to represent multiple connections, relationships or associations between elements. For example, where a connecting element represents a communication of signals, data or instructions, it should be understood by those skilled in the art that such element may represent one or multiple signal paths (e.g., a bus), as may be needed, to effect the communication.

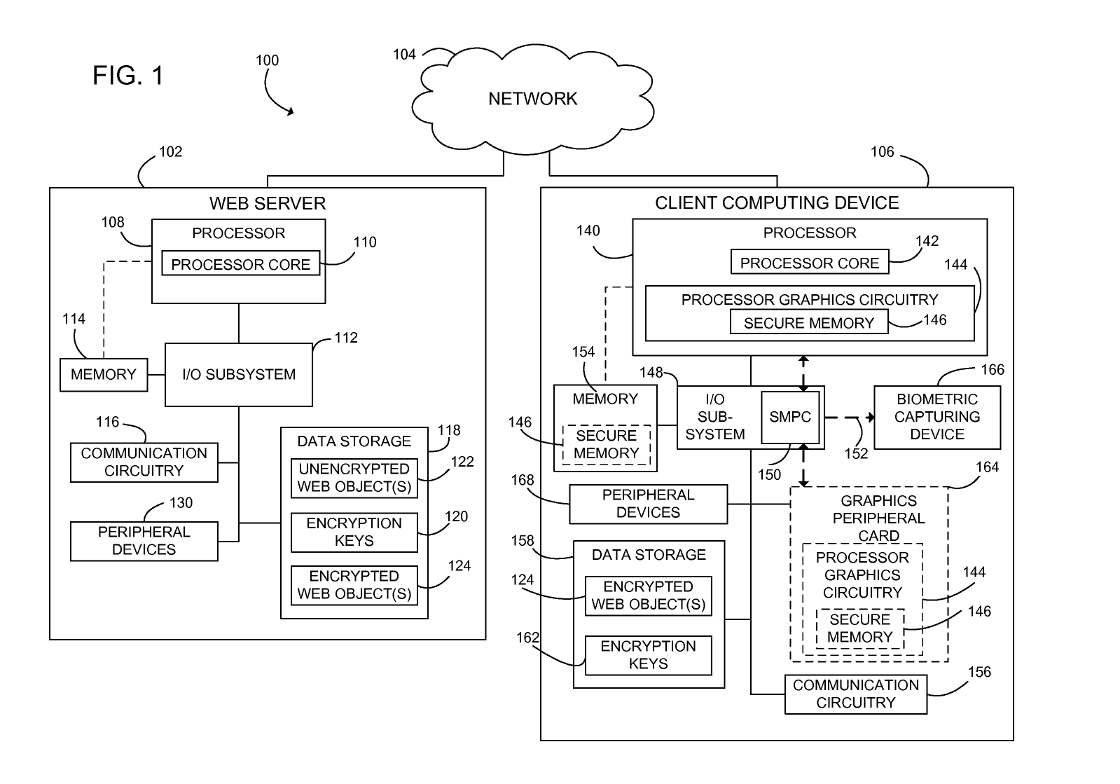

Referring now to FIG. 1, a system 100 for securely displaying web content includes a web server 102 and a client computing device 106. Such web content may include any type of web content deliverable from the web server 102 to the client computing device 106. For example, in some embodiment, the web content may be embodied as a webpage and/or a web-browser application (e.g., an HTML application or the like). In use, as discussed in more detail below, the web server 102 may generate web content with secure web objects accessible to one or more authorized users of the client computing device 106 via a network 104. Although only one web server 102, one network 104, and one client computing device 106 are illustratively shown in FIG. 1, the system 100 may include any number of web servers 102, networks 104, and client computing devices 106 in other embodiments. For example, in some embodiments, the web server 102 may generate web content with secure web objects accessible by several different authorized users of different client computing devices 106.

The web server 102 may be embodied as any type of computing device capable of performing the functions described herein. For example, the web server 102 may be embodied as a desktop computer, a laptop computer, a mobile internet device, a handheld computer, a smart phone, a personal digital assistant, a telephony device, or other computing device. In the illustrative embodiment of FIG. 1, the web server 102 includes a processor 108, an I/O subsystem 112, a memory 114, communication circuitry 116, a data storage device 118, and one or more peripheral devices 130. In some embodiments, several of the foregoing components may be incorporated on a motherboard of the web server 102, while other components may be communicatively coupled to the motherboard via, for example, a peripheral port. Furthermore, it should be appreciated that the web server 102 may include other components, sub-components, and devices commonly found in a computer and/or computing device, which are not illustrated in FIG. 1 for clarity of the description.

The processor 108 of the web server 102 may be embodied as any type of processor capable of executing software/firmware, such as a microprocessor, digital signal processor, microcontroller, or the like. The processor 108 is illustratively embodied as a single core processor having a processor core 110. However, in other embodiments, the processor 108 may be embodied as a multi-core processor having multiple processor cores 110. Additionally, the web server 102 may include additional processors 108 having one or more processor cores 110.

The I/O subsystem 112 of the web server 102 may be embodied as circuitry and/or components to facilitate input/output operations with the processor 108 and/or other components of the web server 102. In some embodiments, the I/O subsystem 112 may be embodied as a memory controller hub (MCH or “northbridge”), an input/output controller hub (ICH or “southbridge”), and a firmware device. In such embodiments, the firmware device of the I/O subsystem 112 may be embodied as a memory device for storing Basic Input/Output System (BIOS) data and/or instructions and/or other information (e.g., a BIOS driver used during booting of the web server 102). However, in other embodiments, I/O subsystems having other configurations may be used. For example, in some embodiments, the I/O subsystem 112 may be embodied as a platform controller hub (PCH). In such embodiments, the memory controller hub (MCH) may be incorporated in or otherwise associated with the processor 108, and the processor 108 may communicate directly with the memory 114 (as shown by the hashed line in FIG. 1). Additionally, in other embodiments, the I/O subsystem 112 may form a portion of a system-on-a-chip (SoC) and be incorporated, along with the processor 108 and other components of the web server 102, on a single integrated circuit chip.

The processor 108 is communicatively coupled to the I/O subsystem 112 via a number of signal paths. These signal paths (and other signal paths illustrated in FIG. 1) may be embodied as any type of signal paths capable of facilitating communication between the components of the web server 102. For example, the signal paths may be embodied as any number of wires, cables, light guides, printed circuit board traces, via, bus, intervening devices, and/or the like.

The memory 114 of the web server 102 may be embodied as or otherwise include one or more memory devices or data storage locations including, for example, dynamic random access memory devices (DRAM), synchronous dynamic random access memory devices (SDRAM), double-data rate synchronous dynamic random access memory device (DDR SDRAM), mask read-only memory (ROM) devices, erasable programmable ROM (EPROM), electrically erasable programmable ROM (EEPROM) devices, flash memory devices, and/or other volatile and/or non-volatile memory devices. The memory 114 is communicatively coupled to the I/O subsystem 112 via a number of signal paths. Although only a single memory device 114 is illustrated in FIG. 1, the web server 102 may include additional memory devices in other embodiments. Various data and software may be stored in the memory device 114. For example, one or more operating systems, applications, programs, libraries, and drivers that make up the software stack executed by the processor 108 may reside in memory 114 during execution. Furthermore, software and data stored in memory 114 may be swapped between the memory 114 and the data storage 118 as part of memory management operations.

The communication circuitry 116 of the web server 102 may be embodied as any number of devices and circuitry for enabling communications between the web server 102 and remote computing devices (e.g., the client computing device 106) over the network 104. The network 104 may be embodied as any number of various wired and/or wireless communication networks. For example, the network 104 may be embodied as or otherwise include a local area network (LAN), a wide area network (WAN), or a publicly-accessible, global network such as the Internet. Additionally, the network 104 may include any number of additional devices to facilitate communication between the web server 102 and the client computing device 106. The web server 102 and the client computing device 106 may use any suitable communication protocol to communicate with each other over the network 104 depending on, for example, the particular type of network(s) 104.

The data storage device(s) 118 may be embodied as any type of device or devices configured for the short-term or long-term storage of data such as, for example, memory devices and circuits, memory cards, hard disk drives, solid-state drives, or other data storage devices. The confidential, unencrypted web object(s) 122 to be shared with the authorized user of the client computing device 106 may be stored in the data storage device 118. Additionally, as discussed in more detail below, one or more encryption keys 120 may be stored in a secure location of the data storage device 118 for use in encrypting the web object(s) 122. In some embodiments, the encrypted web object(s) 124 may be stored in the data storage device 118 to decrease the load on the processor 108 of the web server 102 during web content generation. By encrypting the web object(s) 122 in advance, it is not necessary for the processor 108 to encrypt the web object(s) 122 upon each request by an authorized user to access the web content.

The peripheral devices 130 of the web server 102 may include any number of peripheral or interface devices. For example, the peripheral devices 130 may include a display, a keyboard, a mouse, external speakers, and/or other peripheral devices. The particular devices included in the peripheral devices 130 may depend upon, for example, the intended use of the web server 102. The peripheral devices 130 are communicatively coupled to the I/O subsystem 112 via a number of signal paths thereby allowing the I/O subsystem 112 and/or processor 108 to receive inputs from and send outputs to the peripheral devices 130.

The client computing device 106 may be similar to the web server 102. For example, the client computing device 106 may be embodied as a desktop computer, a laptop computer, a mobile internet device, a handheld computer, a smart phone, a personal digital assistant, a telephony device, or other computing device capable of performing the functions described herein. Further, the client computing device 106 may include components similar to those of the web server 102 discussed above. The description of those components of the web server 102 is equally applicable to the similar components of the client computing device 106 and is not repeated herein for clarity of the description. In the illustrative embodiment of FIG. 1, the client computing device 106 includes a processor 140, an I/O subsystem 148, a memory 154, communication circuitry 156, a data storage device 158, a biometric capturing device 166, and one or more peripheral devices 168. In some embodiments, several of the foregoing components may be incorporated on a motherboard of the client computing device 106, while other components may be communicatively coupled to the motherboard via, for example, a peripheral port. Furthermore, it should be appreciated that the client computing device 106 may include other components, sub-components, and devices commonly found in a computer and/or computing device, which are not illustrated in FIG. 1 for clarity of the description.

In the illustrative embodiment of FIG. 1, the processor 140 includes a processor graphics circuitry 144 defined on a common die with the processor core 142. The processor graphics circuitry 144 is configured to perform various graphics processing functions such as accelerating the generation of graphics and the like. As such, the processor graphics circuitry 144 is typically used to support the generation of graphics on the client computing device 106. In the illustrative embodiment, the processor graphics circuitry 144 includes a secure memory 146. As discussed in further detail below, the secure memory 146 is typically used in conjunction with a secure media path circuitry 150 to provide hardware reinforced security between applications and hardware. In some embodiments, the secure memory 146 may be included in the memory 154 of the client computing device 106 as discussed below. In one embodiment, Protected Audio Video Path (PAVP) may be used to implement such hardware reinforced security using the secure memory 146 and the secure media path circuitry 150. Furthermore, it should be appreciated that alternative implementations of hardware reinforced security may use the secure memory 146 and the secure media path circuitry 150. Although the illustrative processor graphics circuitry 144 is shown in FIG. 1 as being embodied in the processor 140, in other embodiments, the processor graphics circuitry 144 may be included in a graphics peripheral card 164 of the computing device 106. For example, the processor graphics circuitry 144 may be embodied as a graphics processing unit of the graphics peripheral card 164, which may be communicatively coupled to the I/O subsystem 148 via a peripheral bus such as a peripheral component interconnect express (PCIe) bus.

In the illustrative embodiment, the I/O subsystem includes a secure media path circuitry 150. As discussed above, the secure media path circuitry 150 is a hardware reinforced path to securely transfer media. The processor 140 is communicatively coupled to the I/O subsystem 148 via a number of signal paths. Similar to the signal paths of the web server 102, the signal paths of the client computing device 106 may be embodied as any type of signal paths capable of facilitating communication between the components of the client computing device 106. In the illustrative embodiment, the biometric capturing device 166, the processor graphics circuitry 144, and the graphics peripheral card 164 are communicatively coupled to the secure media path circuitry 150 of the I/O subsystem 148 via a number of secure media channels 152. The secure media channels 152 may be embodied as any type of signal paths capable of facilitating secure communication between the biometric capturing device 166, the processor graphics circuitry 144, and the graphics peripheral card 164. For example, the signal paths may be embodied as any number of wires, cables, light guides, printed circuit board traces, via, bus, intervening devices, and/or the like. In some embodiments, the memory 154 may include a portion of secure memory 146. As discussed above, the secure memory 146 may be used for hardware-enforced protection between the application(s) and hardware. In other embodiments, the secure memory 146 may be a separate partition with the memory 154 for use by the processor graphics circuitry 144, the graphics peripheral card 164, and the biometric capturing device 166.

The communication circuitry 156 of the client computing device 106 may be embodied as any number of devices and circuitry for enabling communications between the computing device 106 and remote computing devices (e.g., the web server 102) over the network 104. The data storage device(s) 158 may be embodied as any type of device or devices configured for the short-term or long-term storage of data such as, for example, memory devices and circuits, memory cards, hard disk drives, solid-state drives, or other data storage devices. As discussed in more detail below, when the client computing device 106 downloads the encrypted web object(s) 124 from the web server 102, the encrypted web object(s) 124 may be stored in the data storage device 158. Additionally, one or more private encryption keys 162 may be stored in a secure location of the data storage device 158 for use in decrypting an encrypted symmetric key received with the encrypted web object(s) 124 from the web server 102 as discussed in more detail below. In other embodiments, the encrypted web object(s) 124 and the one or more private encryption keys 162 may be stored in the memory 154 or the secure memory 146.

The biometric capturing device 166 may be embodied as any type of biometric capturing device that is capable of generating real-time biometric data of a user of the client computing device 106. For example, the biometric capturing device may be embodied as a camera, such as a still camera, a video camera, or the like, that is capable of generating real-time images of a user of the computing device 106. Alternatively or in addition, the biometric capturing device may include a fingerprint scanner, handprint scanner, iris scanner, retinal scanner, voice analyzer, or other device to capture any distinguishable human biometric. The biometric capturing device may also include a biometric system, which may be any type of biometric system including multimodal biometric systems. In some embodiments, the biometric capturing device 166 may be incorporated into a housing of the client computing device 106. For example, the biometric capturing device 166 may be a camera incorporated near the display screen of the client computing device 106 such that the user of the client computing device 106 may be monitored while operating the client computing device 106. In particular, the camera may capture the facial image of the current user of the client computing device 106. In other embodiments, the biometric capturing device 166 may be a peripheral device communicatively coupled to the client computing device 106 and positioned so as to monitor the user of the client computing device 106.

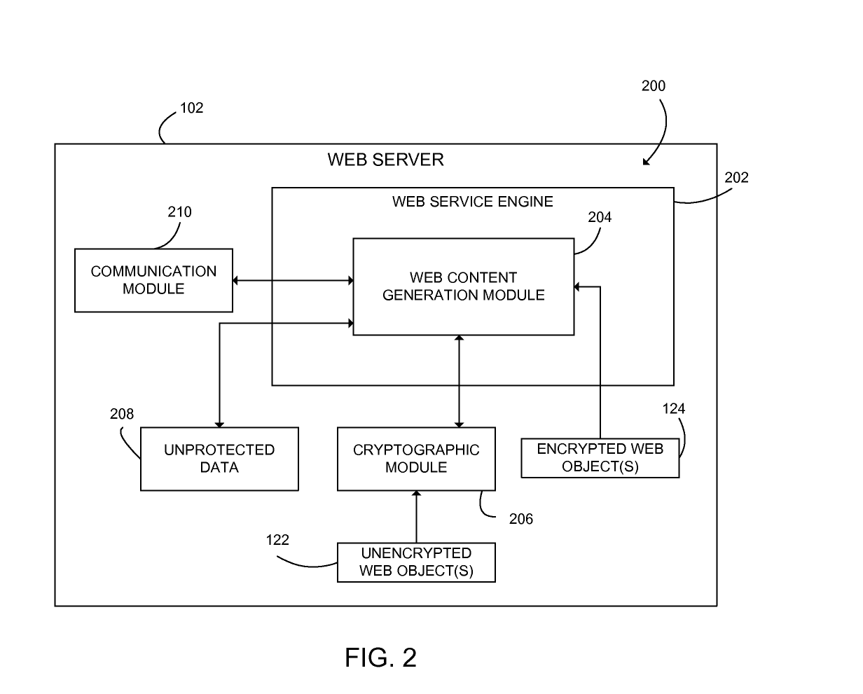

In use, as shown in FIG. 2, the web server 102 may establish an environment 200 for generating web content with secure web object(s) 124. The illustrative environment 200 includes a web service engine 202 executed on the processor 108. A web content generation module 204 may be included in the web service engine 202 to allow the web server 102 to generate web content with secure web objects for the client computing device 106 to access. The web content generation module 204 may be configured to communicate with a cryptographic module 206 to encrypt the unencrypted web object(s) 122 prior to packaging the web object(s) 122 in web content. In some embodiments, the cryptographic module 206 may be embodied as a security co-processor of the web server 102, a cryptographic accelerator incorporated into the processor 108, or a stand-alone cryptographic software/firmware. As discussed above, the web server 102 may encrypt the unencrypted web object(s) 122 with the cryptographic module 206 and store the encrypted web object(s) 124 in the data storage device 118. As such, the web content generation module 204 may access the encrypted web object(s) 124 stored in the data storage device 118 while generating web content. In other embodiments, however, the web content generation module 204 may package the output encrypted web object(s) from the cryptographic module 206 into the web content directly. The web content generation module may also be configured to communicate with a communication module 210 and configured to access unprotected data 208. The communication module 210 may handle the communication between the web server 102 and remote computing devices, including the client computing device 106, through the network 104. Each of the web service engine 202, the cryptographic module 206, and/or the communication module 210 may be embodied as hardware, software, firmware, or a combination thereof.

As discussed in more detail below, the web server 102 may generate web content with secure web objects for users of the client computing device 106 to access via the network 104. To do so, the web content generation module 204 is configured to communicate with the cryptographic module 206 to encrypt the unencrypted web object(s) 122 prior to packaging the encrypted web object(s) 124 in the web content (e.g., a webpage or web-browser application). In the illustrative embodiment, as discussed in more detail below, the unencrypted web object(s) 122 are encrypted with the cryptographic module 206 using a symmetric cryptographic key, which may be generated by the cryptographic module 206. The symmetric cryptographic key is subsequently encrypted using a public key belonging to the designated authorized person (e.g., the user of the client computing device 106). The encrypted symmetric key is then packaged with the encrypted web object(s) 124 in the web content upon a request to access the web content by the client computing device 106. In this way, only the encrypted web object(s) 124 are accessible by the public.

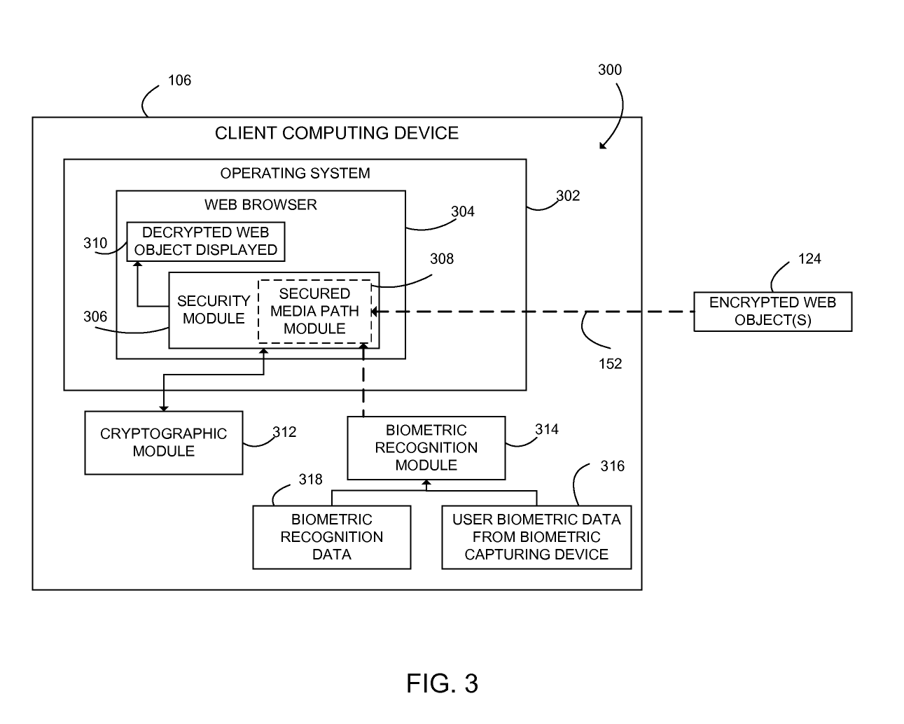

Referring now to FIG. 3, similar to the web server 102, the client computing device 106 may establish a environment 300 for securely accessing and displaying the web object(s) 122. The environment 300 includes an operating system 302 executed by the processor 140. A web browser 304 may be executed by the operating system 302 to allow the client computing device 106 to communicate with the web server 102, for example, to download web content, the encrypted web object(s) 124, and the encrypted symmetric key packaged in the web content, and/or other data. The web browser 304 includes a security module 306, which may be embodied as a browser plug-in, a stand-alone application, or other software/firmware module. The security module 306 is configured to communicate with a cryptographic module 312 to perform various encryption/decryption functions, including decrypting the encrypted web object(s) 124, as discussed in more detail below. Similar to the web server 102, the cryptographic module 312 of the client computing device 106 may be embodied as a security co-processor, a cryptographic accelerator incorporated into the processor 140, or a stand-alone cryptographic software/firmware.

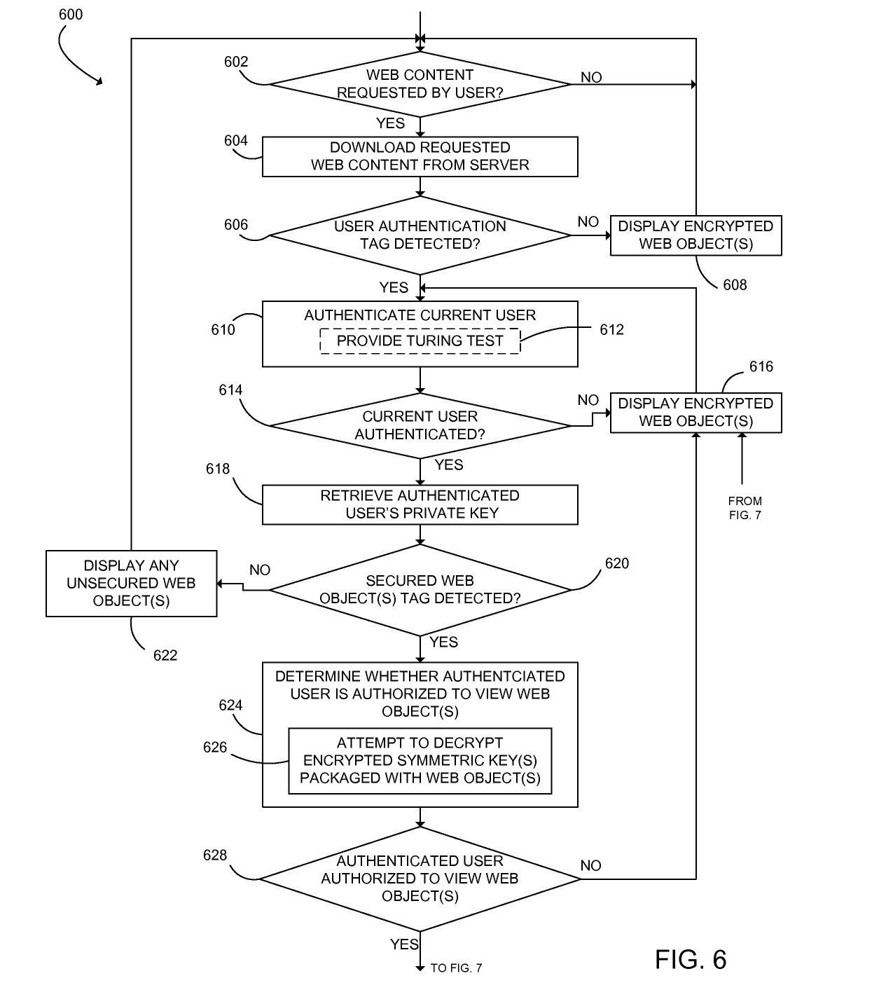

The environment 300 also includes a biometric recognition module 314 executed on the processor graphics circuitry 144 to identify a current user of the client computing device 106 from the real-time biometric data 316 received from the biometric capturing device 166 using pre-trained or predefined biometric recognition data 318, which may be stored in the secure memory 146. To do so, the biometric recognition module 314 may utilize any biometric detection and recognition algorithm capable of analyzing the biometric data 316 generated by the biometric capturing device 166 to authenticate the current user. If the current user is authenticated (i.e., identified as a predefined user) and determined to be authorized to view the web object(s) 122, the security module 306 communicates with the cryptographic module 312 to decrypt the encrypted web object(s) 124 and display the decrypted web object(s) 310 to the authenticated, authorized current user on the client computing device 106 as discussed in more detail below in regard to FIGS. 6-8. In the illustrative embodiment, the encrypted web object(s) 124 and data from the biometric recognition module 314 are communicated to the security module 306 through secure media channels 152 as discussed above. In some embodiments, the security module 306 may also include a secured media path module 308, which may be software/firmware designed to securely interact with the secure media path circuitry 150 in the I/O subsystem 148 of the client computing device 106. In some embodiments, the cryptographic module 312 is linked to or otherwise forms a portion of the secure media path module 308. Each of the security module 306, the cryptographic module 312, and the biometric recognition module 314 may be embodied as hardware, firmware, software, or a combination thereof.

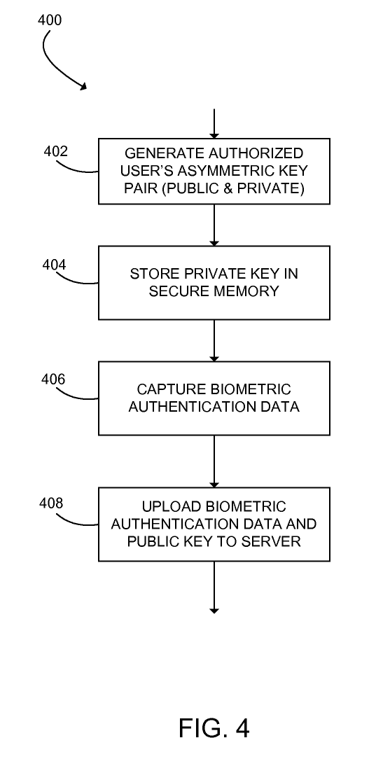

Referring now to FIG. 4, one illustrative embodiment of a method 400 for securely registering an authorized user's biometric authentication data and cryptographic keys, which may be executed by the client computing device 106, begins with block 402. In block 402, the client computing device 106 generates an asymmetric key pair of the authorized user. It should be appreciated that each of a public key and private key is one half of an asymmetric key pair (i.e., public-private cryptographic key pair) as is well known in the art. The asymmetric key pair may be generated using any suitable cryptographic procedure. In one particular embodiment, the public key is generated based on or otherwise using biometric data of the owner of the asymmetric key pair (i.e., the authorized user). For example, the biometric data of the authorized user may be used as a seed value for generating the asymmetric key pair. In other embodiments, the asymmetric key pair may be generated using a Rivest-Shamir-Adleman (RSA) algorithm or elliptic curve cryptography.

In some embodiments, the asymmetric key pair associated with the particular authorized user may be generated by a third party (e.g., through a certificate authority) and securely transmitted to the client computing device 106. After generating or receiving the asymmetric key pair, in block 404, the private key of the asymmetric key pair is stored in secure memory 146. Additionally, in block 406, the biometric capturing device 166 is used to capture biometric authorization data of an authorized user. As discussed above, the biometric capturing device 166 may be embodied as any device suitable to capture real-time biometric data that may be used to authenticate a current user. In block 408, the public key of the authorized user's asymmetric key pair and the captured biometric authentication data of the authorized user are uploaded to the web server 102. Alternatively, the public key and the biometric authentication data are uploaded to the web server 102. In some embodiments, the public key itself need not be uploaded to the web server 102. Rather, the biometric authentication data may be uploaded to the web server 102, and the web server 102 may derive the public key based on the biometric authentication data of the authorized user.

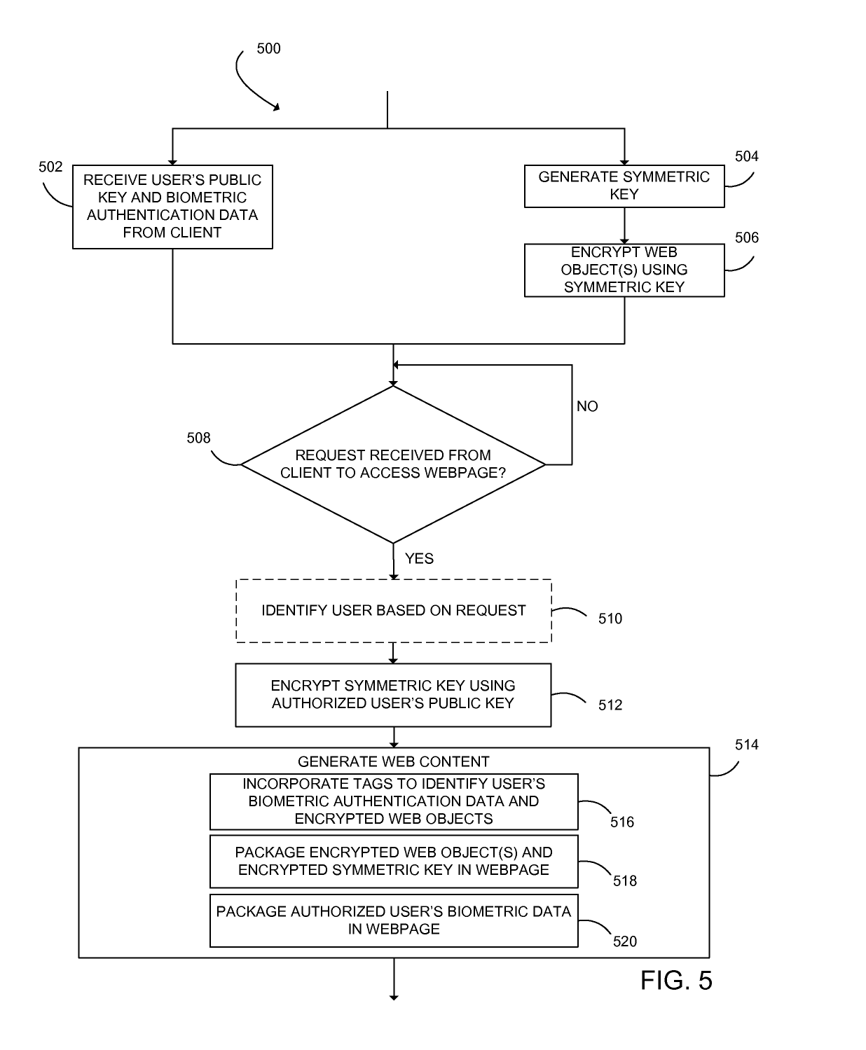

Referring now to FIG. 5, one illustrative embodiment of a method 500 for securely generating web content, which may be executed by the web server 102, begins with block 502 and block 504, which may be executed contemporaneously with each other. In block 502, the web server 102 receives the authorized user's public key and biometric authentication data from the client computing device 106. In block 504, the web server 102 generates a symmetric key and, in block 506, the web server 102 encrypts the web object(s) 122 using the generated symmetric key. In the illustrative embodiment, the web server 102 uses the cryptographic module 206 to generate the symmetric key and encrypt the web object(s) 122. The web object(s) 122 may be encrypted using the same symmetric key, separate symmetric keys, and/or the web object(s) 122 may be grouped such that each group of web object(s) 122 is encrypted with the same symmetric key. In some embodiments, the symmetric key may not be generated on the web server 102 but, instead, generated on another computing device and securely transmitted to the web server 102. In some embodiments, the web server 102 may store the symmetric key in secure memory.

Subsequently, in block 508, the web server 102 determines whether the client computing device 106 has requested access to web content with secure web object(s) 122. If the web server 102 determines that the client computing device 106 has not requested access to web content with secure web object(s) 122, the method 400 does not advance. Therefore, in some embodiments, the web object(s) 122 may not be encrypted until the web server 102 has determined that the client computing device 106 has requested access to such web content. Yet, in other embodiments, the web object(s) 122 may be encrypted prior to the client computing device 106 requesting access to web content with secure web object(s) 122.

If the web server 102 determines that the client computing device 106 has requested access, the method 400 advances to block 512 in which the symmetric key is encrypted using the authorized user's public key. The symmetric key may be separately encrypted using a different public key for each authorized user. Alternatively, a group of users may a share a single private key of the asymmetric key pair such that the symmetric key need be encrypted only once using the single public key to thereby authorize the complete group of users to view the web object(s) 122. In some embodiments, the current user of the client computing device 106 may be identified by the web server 102 based on the request to access the web content in block 510. For example, the web server 102 may identify the requesting user based on certain identification data associated with the web content request (e.g., IP address). In doing so, the web server 102 may use the identifying information to choose the appropriate authorized user's public key when encrypting the symmetric key.

In block 514, the web server 102 generates secure web content for the client computing device 106. In doing so, the web server 102 incorporates tags into the web content to identify the authorized user's biometric authentication data and the encrypted web object(s) 122. The tags incorporated into the web content may be embodied as any tags capable of identifying the authorized user's biometric authentication data and the encrypted web object(s) 122 to the client computing device 106. In some embodiments, the tags may include, or be generated in response to, markup language or scripting language tags (i.e., tags written in HTML, XHTML, XML, JavaScript, etc.) corresponding to the biometric authentication data and the encrypted web object(s) 124. In various embodiments, each of the encrypted web object(s) 124 and biometric authentication data may be identified separately or they may be identified together using a single tag. In other embodiments, additional tags may be present for various other features, such as indicating that the client computing device 106 should authenticate a biometric data feed for the biometric capturing device 166.

In blocks 518 and 520, the encrypted symmetric key, the encrypted web object(s) 124, and the authorized user's biometric data are packaged individually or collectively in the web content. To do so, the encrypted symmetric key, the encrypted web object(s) 124, and the authorized user's biometric data may be packaged as a header or metadata of the web content or otherwise incorporated or associated with the web content. For example, the encrypted symmetric key, the encrypted web object(s) 124, and the authorized user's biometric data may be directly incorporated into the markup or scripting code of the web content. The encrypted web object(s) 124 may thereafter be accessed by both authorized and/or unauthorized users. However, as discussed in more detail below, unauthorized users are capable of viewing only the encrypted web object(s) 124, which is indiscernible to the unauthorized users due to the encryption.

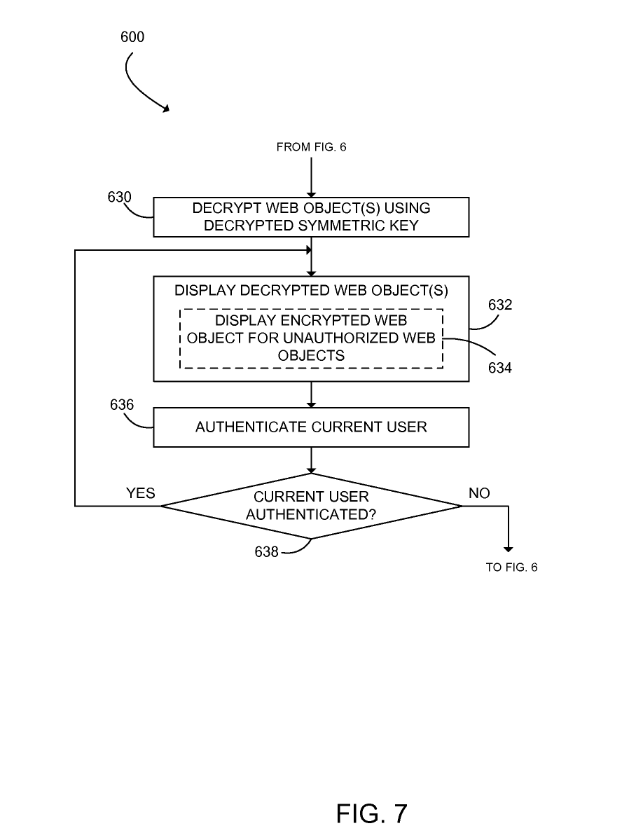

Referring now to FIGS. 6 and 7, one illustrative embodiment of a method 600 for securely displaying web content, which may be executed by the client computing device 106, begins with block 602. In block 602, the client computing device 106 determines whether the current user of the client computing device 106 has requested web content from the web server 102. If so, the method 600 proceeds to block 604 in which the client computing device 106 downloads the requested web content from the web server 102. The web content may be embodied as a standard webpage or web browser application, for example, which may include the encrypted symmetric key, the encrypted web object(s) 124, and the authorized user's biometric data, or may embodied as the encrypted symmetric key, the encrypted web object(s) 124, and the authorized user's biometric data alone. One or more of the encrypted symmetric key, the encrypted web object(s) 124, and the biometric authorization data may be stored in secure memory 146 of the client computing device 106.

In block 606, the client computing device 106 determines whether a user authentication tag has been detected in the web content. As discussed above, the user authentication tag, as well as the secure web object tags, may be embodied as markup language or scripting language tags. If a user authentication tag has not been detected, the client computing device 106 displays the encrypted web object(s) 124 in the web browser 304 in block 608 and returns to block 602. However, if the client computing device 106 has detected a user authentication tag in the web content, the method 600 advances to block 610 in which the current user of the client computing device 106 is authenticated.

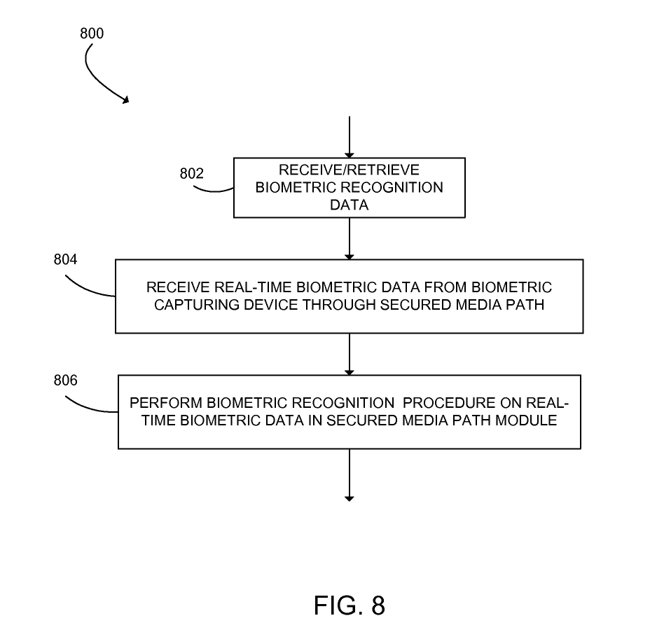

In block 610, the client computing device 106 authenticates the user. To do so, the client computing device 106 may execute a method 800 to authenticate the current user of the client computing device 106 using a biometric recognition procedure as shown in FIG. 8. The method 800 may be executed by, for example, the biometric recognition module 314. The method 800 begins with block 802 in which biometric recognition data is received from the biometric capturing device 166. The biometric recognition data 318 may be embodied as any type of data usable by the client computing device 106 (e.g., the processor graphics circuitry 144) to identify a current user of the client computing device 106 such as pre-generated biometric data, biometric feature data, biometric template data, or other data that may be used for comparison with a real-time image of the current user. For example, as discussed above, a camera may be used as a biometric capturing device 166. In such an embodiment, pre-generated pictures of an authorized user's face or facial feature data may be used as suitable biometric recognition data 318. In some embodiments, the biometric recognition data 318 is previously generated during a training period of the biometric recognition module 314.

In block 804, the biometric recognition module 314 of the client computing device 106 receives real-time biometric data 316 of the current user of the client computing device 106 from the biometric capturing device 166 through the secure media channels 152 and the secure media path circuitry 150. In some embodiments, the secure media path module 308 may be implemented to facilitate the secure transmission of data through the secure media path circuitry 150. As discussed above, the biometric capturing device 166 may be incorporated into the client computing device 106 or otherwise positioned such that the biometric capturing device 166 can generate biometric data 316 of the current user of the client computing device 106. As discussed above, in some embodiments, the biometric capturing device 166 may be a camera positioned such that the current user of the client computing device 106 may be monitored by the camera to verify continued presence of the current user. As discussed in more detail below, some embodiments require the presence of the authorized user for the secure web object(s) 122 to remain decrypted on the web browser 304. In the event that the authorized user is no longer successfully authenticated by the biometric capturing device, the web object(s) 122 may no longer be discernable to the current user of the client computing device 106. In block 806, the biometric recognition module 314 performs a biometric recognition procedure on the real-time biometric data 316 using the biometric recognition data 318 received in block 802 to authenticate the current user. In other words, the biometric recognition procedure may identify the current user as a known user or an unknown user. The biometric recognition module 314 may use any suitable biometric detection and recognition procedure to authenticate the current user.

It should be appreciated that the method 800, and in particular the biometric recognition procedure of block 806, may be a processor-intensive procedure. As such, in the illustrative embodiment, the method 800 is offloaded to the processor graphics circuitry 144 as discussed above in regard to the biometric recognition module 314. By allowing the processor graphics circuitry 144 to execute the method 800 to authenticate the current user, the processor 140 (i.e., processor cores 142) of the client computing device 106 may execute other portions of the method 600 with an increased efficiency and speed. As such, it should be appreciated that although the authentication process of block 610 is shown as being executed serially in method 600, the method 800 performed in the block 610 may be executed by the processor graphics circuitry 144 in parallel with the remainder of the method 600 or portions thereof.

Referring back to FIG. 6, in some embodiments, authentication of the current user of the client computing device 106 may include providing a Turing test or a user presence test to the current user in block 612. In such embodiments, the Turing test or user presence test may be embodied as any test presented to the current user of the client computing device 106 suitable to determine that the current user is physically present. Such tests may, for example, require the user to interact with the client computing device 106 based on information displayed on a display screen of the client computing device 106.

In block 614, the client computing device 106 determines whether the current user has been authentication. If the current user could not be authenticated (e.g., the current user could not be identified, there is no current user of the client computing device 106 present, etc.), the method 600 advances to block 616 in which the client computing device 106 displays the encrypted web object(s) 122 in the web browser 304 and returns to block 610 in which another attempt to authenticate the user is conducted. However, if the current user was successfully authenticated, the method 600 advances to block 618 in which the private key associated with the authenticated user is retrieved from the data storage device 158. As discussed above, the private key is one-half of an asymmetric key pair. Although the public key was previously shared with the web server 102 in block 408 and is generally publically available, the private key is kept secret. As such, the private key may be stored in a secured location of the data storage device 158 or other secure memory 146 of the client computing device 106. Alternatively, the private key may be stored in a secure location on a remote computing device and securely retrieved by the client computing device 106.

In block 620, the client computing device 106 determines whether a secure web object(s) tag has been detected in the web content. As discussed above in block 514, the secure web object(s) tag may be any tag capable of identifying the encrypted web object(s) 124 to the client computing device 106. The tags may include, for example, markup language or scripting language tags corresponding to the encrypted web object(s) 124. If the client computing device 106 does not detect a secure web object(s) tag, the method 600 advances to block 622 in which the client computing device 106 displays any unsecured web object(s) and unsecure web data in the web browser 304 and returns to block 602. In some embodiments, if no secure web object tag is detected, the client computing device 106 may render the web content in the web browser 304 as normal (i.e., as when no secure web object(s) are present).

If the client computing device 106 detects a secure web object(s) tag in block 620, the client computing device 106 determines whether the authenticated user is authorized to view decrypted web object(s) 310 of the encrypted web object(s) 124 in block 624. To do so, the client computing device 106 attempts to decrypt the encrypted symmetric key packaged in the web content with the encrypted web object(s) 124 (see block 518 of method 500). As discussed above in block 512 of method 500, the symmetric key packaged with the encrypted web object(s) is encrypted with the authorized user's public key. Therefore, to decrypt the encrypted symmetric key, the client computing device 106 uses the current user's private key retrieved in block 618. If the current user's private key and the authorized user's public key are a valid asymmetric key pair, the current user's private key will successfully decrypt the encrypted symmetric key. In other words, it should be appreciated that the encrypted symmetric key may only be decrypted if the current/authenticated user is also an authorized user of the web object(s) 122. As discussed above, such decryption process, and other encryption/decryption processes, may be performed by the cryptographic module 312 of the client computer device 106.

If the client computing device 106 is unable to decrypt the encrypted symmetric key using the private key of the authenticated user, the client computing device 106 determines that the current user, while authenticated, is not authorized to view the decrypted web object(s) 122 in block 628. As such, the method 600 advances to block 616 in which the encrypted web object(s) 124 is displayed on the web browser 304 of the client computing device 106. However, if the client computing device 106 is able to decrypt the symmetric key using the private key of the authenticated user, the client computing device 106 determines in block 628 that the authenticated user is authorized to view the decrypted web object(s) 122 of the encrypted web object(s) 124 and advances to block 630. In some embodiments, the client computing device 106 may not determine whether the encrypted symmetric key has been successfully decrypted using the authenticated user's private key. Rather, the client computing device 106 may simply apply the private key to the encrypted symmetric key. If the authenticated user is not authorized to view the decrypted web object(s) 122 of the encrypted web object(s) 124, by applying the authenticated user's private key to the encrypted symmetric key, a pseudo-decrypted symmetric key will be output to the cryptographic module 312 from the cryptographic decryption process as opposed to an accurately decrypted symmetric key.

In block 630, the encrypted web object(s) 124 is decrypted using the decrypted symmetric key, which was decrypted using the authenticated user's private key as discussed above. Again, the decryption process of the encrypted web object(s) 124 may be executed by the cryptographic module 312 of the client computing device 106. In the alternative embodiment discussed above in which a pseudo-decrypted symmetric key is obtained from decrypting the encrypted symmetric key with an unauthorized user's private key, the pseudo-decrypted symmetric key may be applied to the encrypted web object(s) 124. In block 632, the decrypted web object(s) 310 is displayed to the authenticated user on the client computing device 106. In the embodiments discussed above in which a pseudo-decrypted symmetric key is applied to the encrypted web object(s) 124, the output to the cryptographic module 312 of the client computing device 106 will be a pseudo-decrypted web object(s) which is indiscernible to the current user due to the encryption. In other words, applying an unauthorized user's private key to the encrypted symmetric key results in the encrypted web object(s) 124 being displayed on the web browser 304 of the client computing device 106 as in block 616.

As discussed above, a particular user may be authorized to view only certain web object(s) 122; however, in some embodiments, the client computing device 106 may detect multiple web object tags in the web content corresponding to multiple encrypted web object(s) 124. Further, each of the encrypted web object(s) 124 may be encrypted symmetric keys that in turn are encrypted by public keys associated with different authorized users. Therefore, in some embodiments, an authenticated user may be authorized to view one or more of the encrypted web object(s) on the web content but not all of the encrypted web object(s) 124. As such, in block 634 the client computing device 106 may display the encrypted web object(s) 124 on the web browser 304 for those web object(s) 122 in which the authenticated user is not authorized to view.

It should be appreciated that while the decrypted web object(s) 122 is being displayed on the client computing device 106, the authenticated, authorized current user may leave the client computing device 106, be replaced by another user, or otherwise stop operating the client computing device 106. As such, the current user is cyclically, continuously, periodically, and/or aperiodically authenticated in blocks 636 and 638 while the decrypted web object(s) 122 is displayed on the client computing device 106. In various embodiments, the current user may be authenticated in any random, chaotic, or ordered set of intervals. The current user may also be authenticated in response to atemporal events. To do so, the client computing device 106 may execute the method 800 to authenticate the current user in block 636. As discussed above, the method 800 may be executed by the processor graphics circuitry 144 in parallel and contemporaneously with portions of the method 600. Should the current user no longer be authenticated (e.g., the current user leaves the client computing device 106), the method 600 advances to block 616 in which the decrypted web object(s) 122 is replaced with the encrypted web object(s) 124. In this way, the authorized current user is cyclically, continuously, periodically, and/or aperiodically authenticated at the client computing device 106 while the decrypted web object(s) 122 is displayed on the client computing device 106. As such, the confidentially of the web object(s) 122 is secured not only during transit through the untrusted channel (e.g., the network 104), but also at the client computing device 106 by ensuring only an authorized user is allowed to view the web object(s) 122 on the client computing device 106.

### EXAMPLES

Illustrative examples of the devices, systems, and methods disclosed herein are provided below. An embodiment of the devices, systems, and methods may include any one or more, and any combination of, the examples described below.

Example 1 includes a computing device for securely displaying a web content. The computing device includes a security module to detect a user authentication tag and a secure web object tag in the web content, the user authentication tag to identify biometric authentication data and the secure web object tag to identify an encrypted web object; a biometric recognition module to (i) receive biometric data from a current user of the computing device and (ii) authenticate the current user of the computing device as a function of the received biometric data and the biometric authentication data; and a cryptographic module to, in response to the user being authenticated, (i) decrypt an encrypted symmetric key packaged in association with the encrypted web object and (ii) decrypt the encrypted web object using the decrypted symmetric key, wherein the decrypted web object is displayed to the current user on a display of the computing device.

Example 2 includes the subject matter of Example 1, and wherein the biometric recognition module comprises a processor graphics circuitry.

Example 3 includes the subject matter of any of Example 1 and 2, and wherein the biometric recognition module is configured to receive the biometric data received from the current user and the biometric authentication data through a secure media path circuitry.

Example 4 includes the subject matter of any of Examples 1-3, and wherein the secure media path circuitry comprises a protected audio video path.

Example 5 includes the subject matter of any of Examples 1-4, and wherein the biometric authentication data is to be stored in a secure memory within a processor graphics circuitry.

Example 6 includes the subject matter of any of Examples 1-5, and wherein the processor graphics circuitry is located on a common die with a central processing unit of the computing device.

Example 7 includes the subject matter of any of Examples 1-6, and wherein the processor graphics circuitry is located on a peripheral graphics card of the computing device.

Example 8 includes the subject matter of any of Example 1-7, and further including a biometric capturing device to generate the biometric data of the current user.

Example 9 includes a server for generating a secure web content, the method comprising a communication module to receive a public key of an authorized user and biometric authentication data of the authorized user; a cryptographic module to (i) encrypt a web object using a symmetric key stored on the server and (ii) encrypt the symmetric key using the public key of the authorized user; and a web content generation module to generate web content including (i) a user authentication tag to identify the biometric authentication data and (ii) a secure web object tag to identify the encrypted web object, wherein the web content generating module packages the encrypted web object, the encrypted symmetric key, and the biometric authentication data in the web content.

Example 10 includes the subject matter of Example 9, and wherein the symmetric key stored on the server is to be generated on the server.

Example 11 includes the subject matter of any of Examples 9 and 10, and wherein the user authentication tag and the secure web object tag are generated in response to corresponding markup language tags in a code of the web content.

Example 12 includes a method for securely displaying web content on a computing device. The method includes detecting a user authentication tag in the web content, the user authentication tag to identify biometric authentication data; in response to detecting the user authentication tag, authenticating a current user of the computing device as a function of the biometric authentication data and biometric data received from the current user; detecting a secure web object tag in the web content, the secure web object tag to identify an encrypted web object; determining whether the authenticated current user is authorized to view a decrypted web object of the encrypted web object; and in response to detecting the secure web object tag and the current user having been authenticated, (i) decrypting the encrypted web object and (ii) displaying the decrypted web object on the computing device.

Example 13 includes the subject matter of Example 12, and wherein detecting the user authentication tag comprises detecting a markup language tag.

Example 14 includes the subject matter of any of Examples 12 and 13, and wherein authenticating the current user comprises cyclically authenticating the current user.

Example 15 includes the subject matter of any of Examples 12-14, and wherein authenticating the current user of the computing device comprises comparing the biometric authentication data with the biometric data received from the current user.

Example 16 includes the subject matter of any of Examples 12-15, and wherein authenticating the current user of the computing device comprises comparing the biometric authentication data with biometric data received from the current user that is captured in real-time using a biometric capturing device of the computing device.

Example 17 includes the subject matter of any of Examples 12-16, and wherein authenticating the current user of the computing device comprises presenting, on the computing device, a Turing test to the current user.

Example 18 includes the subject matter of any of Examples 12-17, and wherein authenticating the current user of the computing device comprises authenticating the current user as a function of the biometric authentication data and a captured facial image of the current user.

Example 19 includes the subject matter of any of Examples 12-18, and wherein authenticating the current user of the computing device comprises authenticating the current user as a function of the biometric authentication data and a captured fingerprint of the current user.

Example 20 includes the subject matter of any of Examples 12-19, and wherein authenticating the current user of the computing device comprises authenticating the current user as a function of a biometric template of the biometric authentication data and the biometric data.

Example 21 includes the subject matter of any of Examples 12-20, and wherein detecting the secure web object tag in the web content comprises detecting a markup language tag.

Example 22 includes the subject matter of any of Examples 12-21, and further including retrieving an encrypted symmetric key packaged in the web content.

Example 23 includes the subject matter of any of Examples 12-22, and wherein the encrypted symmetric key is packaged with the encrypted web object in the web content.

Example 24 includes the subject matter of any of Examples 12-23, and wherein determining whether the authenticated current user is authorized to view the decrypted web object of the encrypted web object comprises retrieving, on the computing device, an asymmetric private key of the current user; and decrypting the encrypted symmetric key using the current user's asymmetric private key.

Example 25 includes the subject matter of any of Examples 12-24, and wherein the encrypted web object is decrypted using the decrypted symmetric key.

Example 26 includes the subject matter of any of Examples 12-25, and further including generating an asymmetric key pair of an authorized user, the asymmetric key pair comprising a public key and a private key; storing the authorized user's private key in secure memory; capturing the biometric authentication data of the authorized user with a biometric capturing device of the computing device; and uploading the biometric authentication data and the authorized user's public key to a web server, wherein the encrypted symmetric key is encrypted with the authorized user's public key.

Example 27 includes the subject matter of any of Examples 12-26, and wherein generating the asymmetric key pair comprises generating an asymmetric key pair as a function of the captured biometric authentication data of the authorized user.

Example 28 includes the subject matter of any of Examples 12-27, and further including displaying, in response to an unauthorized current user decrypting the encrypted web object, a form decrypted web object on the computing device remains encrypted.

Example 29 includes the subject matter of any of Examples 12-28, and further including displaying a remaining portion of the web content in response to detecting no secure web object tag in the web content.

Example 30 includes the subject matter of any of Examples 12-29, and further including transferring the biometric authentication data and the biometric data to a processor graphics circuitry of the computing device via a secure media path circuitry.

Example 31 includes the subject matter of any of Examples 12-30, and wherein the secure media path circuitry is a protected audio video path.

Example 32 includes a computing device comprising a processor; and a memory having stored therein a plurality of instructions that when executed by the processor cause the computing device to perform the method of any of Examples 12-31.

Example 33 includes one or more machine readable storage media comprising a plurality of instructions stored thereon that in response to being executed result in a computing device performing the method of any of Examples 12-31.

Example 34 includes a method for generating secure web content. The method includes encrypting, on a server, a web object using a symmetric key of the server; receiving a public key of an authorized user and biometric authentication data of the authorized user from a computing device; encrypting, on the server, the symmetric key using the public key of the authorized user; and generating web content including (i) a user authentication tag to identify the biometric authentication data and (ii) a secure web object tag to identify the encrypted web object, wherein the encrypted web object, the encrypted symmetric key, and the biometric authentication data are packaged in the web content.

Example 35 includes the subject matter of Example 34, and wherein encrypting, on a server, a web object using a symmetric key of the server comprises encrypting the web object using the symmetric key of the server generated on the server.

Example 36 includes the subject matter of any of Examples 34 and 35, and wherein generating the web content comprises generating the user authentication tag in response to a corresponding markup language tag in a code of the web content.

Example 37 includes the subject matter of any of Examples 34-36, and wherein generating the web content comprises generating the secure web object tag in response to a corresponding markup language tag in a code of the web content.

Example 38 includes the subject matter of any of Examples 34-37, and wherein generating the web content is in response to a request from the computing device to access the web content.

Example 39 includes the subject matter of any of Examples 34-38, and wherein encrypting the symmetric key and generating the web content are in response to a request from the computing device to access the web content.

Example 40 includes the subject matter of any of Examples 34-39, and further including identifying a current user based on a request to access the web content.

Example 41 includes the subject matter of any of Examples 34-40, and wherein identifying the current user comprises identifying an IP address of the current user.

Example 42 includes a server comprising a processor; and a memory having stored therein a plurality of instructions that when executed by the processor cause the server to perform the method of any of Examples 34-41.

Example 43 includes one or more machine readable storage media comprising a plurality of instructions stored thereon that in response to being executed result in a server performing the method of any of Examples 34-41.

1. A computing device for securely displaying web content, the computing device comprising:
a security module to detect a user authentication tag and a secure web object tag in the web content, the user authentication tag to identify biometric authentication data and the secure web object tag to identify an encrypted web object;
a biometric recognition module to (i) receive biometric data from a current user of the computing device and (ii) authenticate the current user of the computing device as a function of the received biometric data and the biometric authentication data; and
a cryptographic module to, in response to the user being authenticated, (i) decrypt an encrypted symmetric key packaged in association with the encrypted web object and (ii) decrypt the encrypted web object using the decrypted symmetric key,
wherein the decrypted web object is displayed to the current user on a display of the computing device.

2. The computing device of claim 1, wherein the biometric recognition module comprises a processor graphics circuitry.

3. The computing device of claim 1, wherein the biometric recognition module is configured to receive the biometric data and the biometric authentication data through a secure media path circuitry.

4. The computing device of claim 3, wherein the secure media path circuitry comprises a protected audio video path.

5. The computing device of claim 1, wherein the biometric authentication data is to be stored in a secure memory within a processor graphics circuitry.

6. The computing device of claim 1, further comprising a biometric capturing device to generate the biometric data of the current user.

7. A server for generating secure web content, the server comprising:
a communication module to receive a public key of an authorized user and biometric authentication data of the authorized user;
a cryptographic module to (i) encrypt a web object using a symmetric key stored on the server and (ii) encrypt the symmetric key using the public key of the authorized user; and
a web content generation module to generate web content including (i) a user authentication tag to identify the biometric authentication data and (ii) a secure web object tag to identify the encrypted web object,
wherein the web content generation module packages the encrypted web object, the encrypted symmetric key, and the biometric authentication data in the web content.

8. The server of claim 7, wherein the user authentication tag and the secure web object tag are generated in response to corresponding markup language tags in a code of the web content.

9. One or more machine-readable storage media comprising a plurality of instructions stored thereon that, in response to being executed, result in a computing device:
detecting a user authentication tag in the web content, the user authentication tag to identify biometric authentication data;
in response to detecting the user authentication tag, authenticating a current user of the computing device as a function of the biometric authentication data and biometric data received from the current user;
detecting a secure web object tag in the web content, the secure web object tag to identify an encrypted web object;
determining whether the authenticated current user is authorized to view a decrypted web object of the encrypted web object; and
in response to detecting the secure web object tag and the current user having been authenticated and authorized, (i) decrypting the encrypted web object and (ii) displaying the decrypted web object on the computing device.

10. The one or more machine-readable storage media of claim 9, wherein detecting at least one of the user authentication tag and the secure web object tag comprises detecting a markup language tag.

11. The one or more machine-readable storage media of claim 9, wherein authenticating the current user comprises cyclically authenticating the current user.

12. The one or more machine-readable storage media of claim 9, wherein authenticating the current user of the computing device comprises comparing the biometric authentication data with the biometric data received from the current user.

13. The one or more machine-readable storage media of claim 9, wherein authenticating the current user of the computing device comprises comparing the biometric authentication data with biometric data received from the current user that is captured in real-time using a biometric capturing device of the computing device.

14. The one or more machine-readable storage media of claim 9, wherein authenticating the current user of the computing device comprises authenticating the current user as a function of the biometric authentication data and at least one of a captured facial image of the current user or a captured fingerprint of the current user.

15. The one or more machine-readable storage media of claim 9, wherein authenticating the current user of the computing device comprises authenticating the current user as a function of a biometric template of the biometric authentication data and the biometric data.

16. The one or more machine-readable storage media of claim 9, wherein the plurality of instructions further result in the computing device retrieving an encrypted symmetric key packaged in the web content.

17. The one or more machine-readable storage media of claim 16, wherein determining whether the authenticated current user is authorized to view the decrypted web object of the encrypted web object comprises:
retrieving, on the computing device, an asymmetric private key of the current user; and
decrypting the encrypted symmetric key using the current user's asymmetric private key,
wherein the encrypted web object is decrypted using the decrypted symmetric key.

18. The one or more machine-readable storage media of claim 17, wherein the plurality of instructions further result in the computing device:
generating an asymmetric key pair of an authorized user, the asymmetric key pair comprising a public key and a private key;
storing the authorized user's private key in secure memory;
capturing the biometric authentication data of the authorized user with a biometric capturing device of the computing device; and
uploading the biometric authentication data and the authorized user's public key to a web server,
wherein the encrypted symmetric key is encrypted with the authorized user's public key.

19. The one or more machine-readable storage media of claim 9, wherein the plurality of instructions further result in the computing device displaying, in response to the current user not being authorized, an encrypted version of the decrypted web object.

20. The one or more machine-readable storage media of claim 9, wherein the plurality of instructions further result in the computing device displaying a remaining portion of the web content in response to detecting no secure web object tag in the web content.

21. The one or more machine-readable storage media of claim 9, wherein the plurality of instructions further result in the computing device transferring the biometric authentication data and the biometric data to a processor graphics circuitry of the computing device via a secure media path circuitry.

22. The one or more machine-readable storage media of claim 21, wherein the secure media path circuitry is a protected audio video path.

23. One or more machine-readable storage media comprising a plurality of instructions stored thereon that, in response to being executed, result in a computing device:
encrypting, on a server, a web object using a symmetric key of the server;
receiving a public key of an authorized user and biometric authentication data of the authorized user from a computing device;
encrypting, on the server, the symmetric key using the public key of the authorized user; and
generating web content including (i) a user authentication tag to identify the biometric authentication data and (ii) a secure web object tag to identify the encrypted web object,
wherein the encrypted web object, the encrypted symmetric key, and the biometric authentication data are packaged in the web content.

24. The one or more machine-readable storage media of claim 23, wherein encrypting, on a server, a web object using a symmetric key of the server comprises encrypting the web object using the symmetric key of the server generated on the server.

25. The one or more machine-readable storage media of claim 23, wherein generating the web content comprises generating the user authentication tag in response to a corresponding markup language tag in a code of the web content.

26. The one or more machine-readable storage media of claim 23, wherein generating the web content comprises generating the secure web object tag in response to a corresponding markup language tag in a code of the web content.
